(19) United States
(12) Patent Application Publication
(10) Pub. No.: US 2009/0243930 A1
(43) Pub. Date: Oct. 1, 2009

(54) Method of generating better communication direction

(75) Inventor: Kai-Wen Tien, Tainan City (TW)

Correspondence Address: REED SMITH LLP, Suite 1400, 3110 Fairview Park Drive, Falls Church, VA, 22042, US

(73) Assignee: Quanta Computer Inc.

(21) Appl. No.: 12/222,490

(22) Filed: Aug. 11, 2008

(30) Foreign Application Priority Data
Mar. 26, 2008 (TW) 097110680

(51) Int. Cl. H01Q 3/00

(52) U.S. Cl. 342/360

(57) ABSTRACT

The invention discloses a method for generating better communication direction. The method comprises the following steps of: (a) positioning a first communication device to obtain a first position; (b) positioning a second communication device to obtain a second position; (c) associating the first position with the second position to obtain a relative direction; (d) defining a first reference direction according to a first antenna pattern of the first communication device; (e) calculating a first angle between the relative direction and the first reference direction; and (f) adjusting the first communication device toward the relative direction according to the first angle. Accordingly, the first communication device can perform communication in better communication direction.

### BACKGROUND OF THE INVENTION

1. Field of the invention

The invention relates to a method for generating a better communication direction, so as to improve communication quality.

2. Description of the prior art

In prior art, a communication system searches signals in a specific area with a smart antenna, so as to acquire a better communication direction. Please refer to FIG. 1. FIG. 1 is a schematic diagram illustrating a beam-forming of a smart antenna. In FIG. 1, dashed lines symbolize directions of incoming signals, and solid lines symbolize directions of incoming noises. In general, a better communication quality may be achieved by directing the higher gain of the antenna pattern to the signal source, and directing the lower gain (especially the null) of the antenna pattern to the noise source. A method of the prior art for generating a beam-forming comprises steps of:

evaluating directions of the incoming signals, wherein it may be achieved by Direction of Arrival (DOA) algorithm;

differentiating desired signals and noises from the incoming signals to acquire the directions of desired signals and noises; and

generating the beam-forming based on foresaid step (1) and step (2).

However, for a general mobile device, the cost will increase a lot when installing a smart antenna for wireless communication.

Therefore, a scope of the invention is to provide a method for generating a better communication direction, so as to solve the aforesaid problems.

### SUMMARY OF THE INVENTION

A scope of the invention is to provide a method for generating a better communication direction. The method can be applied to establish wireless communication between a plurality of mobile devices, or, between a system end and at least one mobile device. Especially, when the method is used to establish wireless communication between a system end with a smart antenna and a mobile device, the system end may provide service for more client ends, and the quality of service (QoS) will be better.

According to an embodiment of the invention, a method for generating better communication direction comprises steps of a) positioning a first communication device to obtain a first position, b) positioning a second communication device to obtain a second position, c) associating the first position with the second position to obtain a relative direction, d) defining a first reference direction according to a first antenna pattern of the first communication device, e) calculating a first angle between the relative direction and the first reference direction, and f) adjusting the first communication device toward the relative direction according to the first angle. Accordingly, the first communication device can perform communication toward a better communication direction.

According to another embodiment of the invention, a method for generating better communication direction comprises steps of a) positioning a first communication device to obtain a first position, b) positioning a second communication device to obtain a second position, wherein the second communication device has a Received Signal Strength (RSS) distribution map, c) associating the first position with the second position to obtain a relative direction, d) defining a first reference direction according to a first antenna pattern of the first communication device, e) calculating a first angle between the relative direction and the first reference direction, f) transmitting the first angle and an RSS signal, which is corresponding to the first angle, from the first communication device to the second communication device, g) repeating step a to step f for N times, mapping N first angles and N RSS signals onto the RSS distribution map, wherein N is a positive integer, and h) adjusting a communication direction of a third communication device according to the RSS distribution map. Accordingly, the third communication device can perform communication toward a better communication direction.

According to another embodiment of the invention, a method for generating better communication direction, comprising steps of a) positioning a first communication device to obtain a first position, b) positioning a second communication device to obtain a second position, c) associating the first position with the second position to obtain a relative direction, d) defining a first reference direction according to a first antenna pattern of the first communication device, e) calculating a first angle between the relative direction and the first reference direction, f) transmitting the first angle and the first antenna pattern from the first communication device to the second communication device, and g) according to the first angle and the first antenna pattern, directing a main beam of a second antenna of the second communication device into a range of another main beam of the first antenna. Accordingly, the first communication device can perform communication toward a better communication direction.

The advantage and spirit of the invention may be understood by the following recitations together with the appended drawings.

### BRIEF DESCRIPTION OF THE APPENDED DRAWINGS

FIG. 1 is a schematic diagram illustrating a beam-forming of a smart antenna.

FIG. 2 is a schematic diagram illustrating a communication system.

FIG. 3 is a functional block diagram illustrating the communication device shown in FIG. 2.

FIG. 4 is a schematic diagram illustrating an antenna pattern and an axis coordinate system (X′, Y′) defined by an axis sensor.

FIG. 5 is a schematic diagram illustrating a reference direction coordinate system defined by an antenna pattern (i.e., main beam).

FIG. 6 is a schematic diagram illustrating two reference direction coordinate systems of two directional patterns and a communication direction between the two directional patterns.

FIG. 7 is a schematic diagram illustrating reference direction coordinate systems and a communication direction between an omni-directional pattern and a directional pattern.

FIG. 8 is a schematic diagram illustrating reference direction coordinate systems and a communication direction between a smart antenna and a directional pattern.

FIG. 9 is a schematic diagram illustrating a Received Signal Strength (RSS) distribution map.

FIG. 10 is a flowchart illustrating an embodiment of a method for generating a better communication direction of the invention.

FIG. 11 is a flowchart illustrating another embodiment of a method for generating a better communication direction of the invention.

FIG. 12 is a flowchart illustrating another embodiment of a method for generating a better communication direction of the invention.

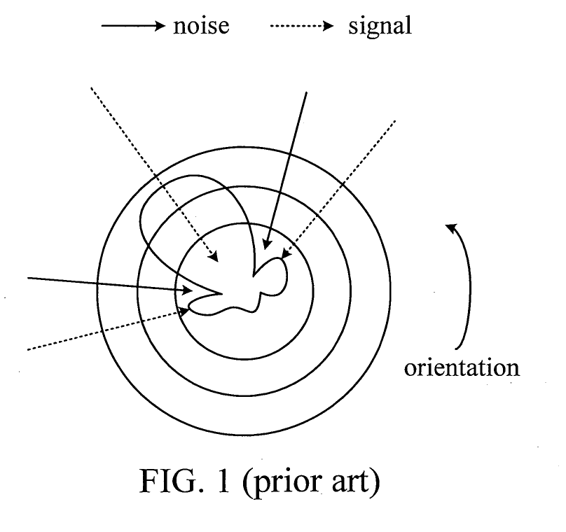

### DETAILED DESCRIPTION OF THE INVENTION

The mobile device nowadays follows the trend of having multiple antennas. For example, a mobile device, which complies with 802.11a/b/g, usually has two antennas. A mobile device, which complies with 802.11n, may utilize three or more antennas. A mobile device in the invention may arrange different antenna patterns together. Taking two antennas for example, one may have an omni-directional pattern and the other may have a directional pattern.

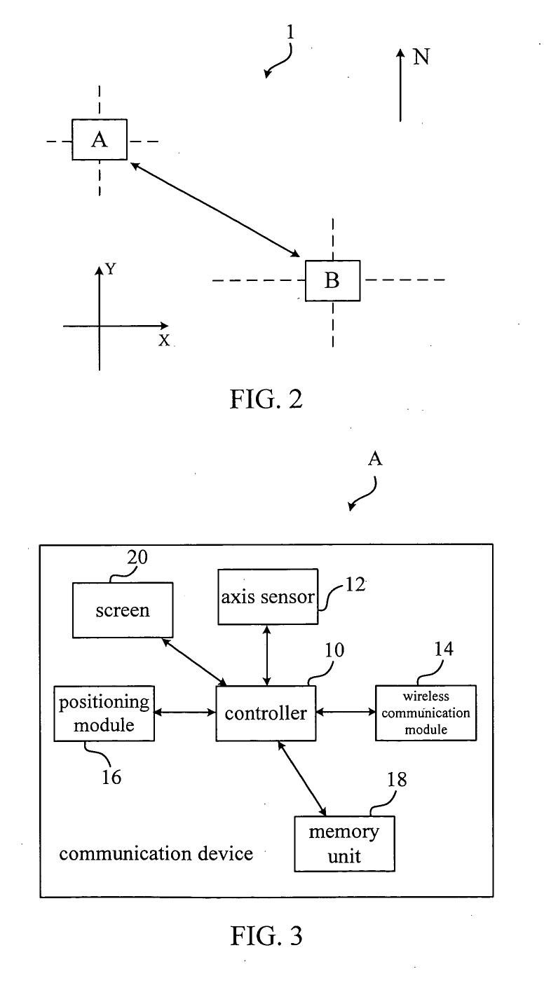

Please refer to FIG. 2 and FIG. 3. FIG. 2 is a schematic diagram illustrating a communication system 1. FIG. 3 is a functional block diagram illustrating the communication device A, as shown in FIG. 2.

As shown in FIG. 2, the communication system 1 comprises a communication device A and a communication device B. The communication device A is capable of establishing wireless communication with the communication device B to transmit signals or messages.

As shown in FIG. 3, the communication device A comprises a controller 10, an axis sensor 12, a wireless communication module 14, a positioning module 16, and a memory unit 18. The controller 10 is further connected to system hardware (not shown) of some apparatus (i.e. mobile phone, PDA). Besides, the controller 10 may also be connected to a display 20, which is used for displaying a better communication direction. The axis sensor 20 can be a magnetic sensor for defining the magnetic north of the earth, as shown by the arrow with symbol N in FIG. 2. Because there is a certain angle between magnetic north and geographic north, geographic north can be inferred as long as the magnetic north is known (referred as “geographic north” for demonstrative convenience). Besides, as long as the geographic north is oriented, it can acquire an antenna pattern orientation of the communication device A and defines a reference direction. The wireless communication module 14 is needed for signal transmitting in wireless communication. The invention provides a method for the wireless communication module 14 to automatically generate better direction. The positioning module 16 is needed to calculate for positioning. The memory unit 18 is mainly for storing the antenna pattern data. A communication device B in FIG. 2 is similar to the communication device A in basic structure, so the introduction will not be repeated here.

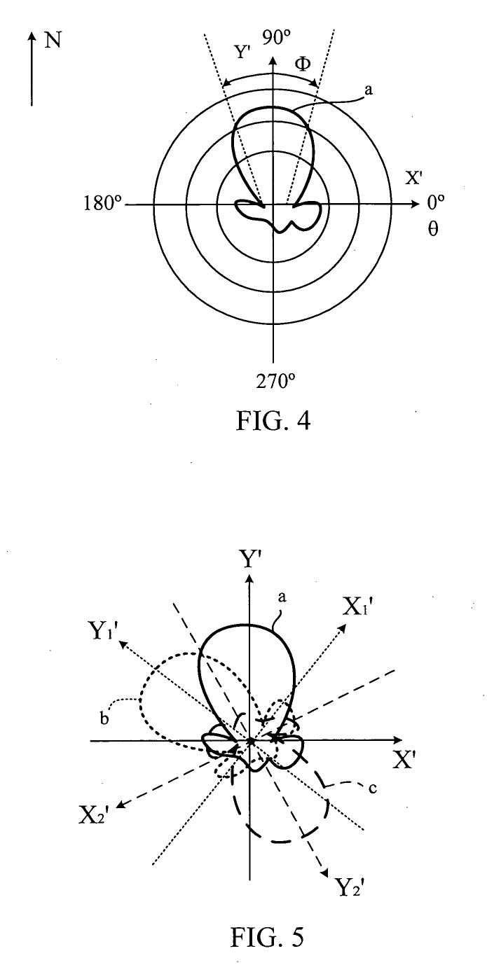

Please refer to FIG. 4 and FIG. 5. FIG. 4 is a schematic diagram illustrating an antenna pattern and an axis coordinate system (X′, Y′) defined by an axis sensor. FIG. 5 is a schematic diagram illustrating a reference direction coordinate system defined by an antenna pattern (i.e. main beam).

In FIG. 4, X′ and Y′ in the axis coordinate system, which is defined by the axis sensor, wherein the north defined by the axis sensor is earth magnetic north (can be converted into geographic north), therefore, the axis coordinate system is an absolute coordinate system (i.e. absolute geographic coordinate). On the other hand, in FIG. 4, the antenna pattern within angle Φ (width of main beam angle in a directional antenna) is a higher gain section of antenna pattern, and a reference direction coordinate system could be defined according thereto, which differs from corresponding to a frontal of the communication device, and the frontal doesn't necessarily match the main beam orientation (antenna pattern orientation). In brief, the reference direction coordinate system is a relative coordinate and not unique. For example, to assume that the frontal is toward the north and the main beam is toward the west at the same time, while rotating the communication device clockwise by 90 degree to face the east, the main beam follows and rotates clockwise by 90 degree to point toward the north.

In FIG. 4, the main beam a is pointing toward the geographic north, so the axis coordinate system defined by the axis sensor matches the reference direction coordinate system defined by the main beam (the same orientation). Furthermore, FIG. 5 is a schematic diagram illustrating the main beam a in FIG. 4 is rotating in two different directions to form a main beam b and a main beam c. The reason of having different directions is that the communication device does not necessarily point to a specific direction, especially for mobile devices which may rotate frequently.

Because the geographic north is on the absolute coordinate, any communication device with an axis sensor can detect not only a main beam orientation of its own, but also relative orientation between the main beam and the geographic north. If a main beam orientation and a relative location of another communication device are available, a better direction may be achieved by rotating the first mentioned communication device or both communication devices to match each other appropriately, according to the relative location between those two communication devices.

Aforesaid relative location can be calculated by the positioning module 16. A GPS (Global Positioning System), an example of the positioning module, can position the absolute location. By knowing the absolute location, the relative location can be inferred. In some other cases, a relative location between two communication devices can be generated at a system end, and transmitted to both communication devices afterward.

The mobile device nowadays is on the trend of having multiple antennas. Take 802.11a/b/g for example, which usually has two antennas. In the next generation of WiFi standard, 802.11n may utilize three antennas or more. A mobile device in the invention may arrange different antenna pattern together. Taking two antennas for example, one may have an omni-directional pattern and the other may have a directional pattern.

### First Embodiment: (Axis Coordinate Systems, Reference Direction Coordinate Systems)

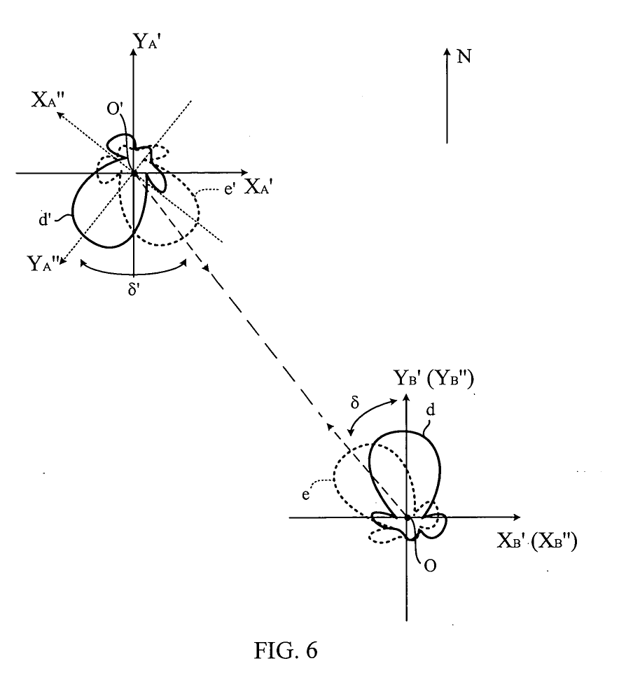

Please refer to FIG. 6. FIG. 6 is a schematic diagram illustrating two reference direction coordinate systems of two directional patterns and a communication direction between the two directional patterns. The antenna pattern (the main beam) d′ is in direction of an original antenna pattern of a communication device A. X_{A}′, Y_{A}′ represents an axis coordinate system, which is defined by an axis sensor 12 of the communication device A, while X_{A}″, Y_{A}″ represents a reference direction coordinate system of the communication device A, defined by the antenna pattern d′ orientation. The pattern d′ orientation can be inferred from the geographic north N or the Y_{A}′ axis (as in FIG. 6, toward southwest approximately). In the same way, X_{B}′, Y_{B}′ represents another axis coordinate system of the communication device B, defined by another axis sensor 12 of the communication device B, while X_{B}″, Y_{B}″ represents another reference direction coordinate system of the communication device B, defined by the antenna pattern d orientation. The pattern d orientation can be inferred from the geographic north N or the Y_{B}′ axis (as in FIG. 6, toward north approximately). Besides, the relative location between the communication device A and the communication device B can be calculated with absolute locations (i.e. origin O′ and origin O), which are located by the positioning module 16. For example, the communication device A is located at the northwestern side of the communication device B, in other words, the communication device B is located at the southeastern side of the device A.

After the orientations of the antenna pattern d′, the antenna pattern d, and the relative location were acquired, a better communication is obtained by making the antenna patterns d′ and d face each other, in other words, to make orientations of antenna pattern d′ and d located on a relative direction \vec{OO}′. As shown in FIG. 6, the communication device A calculates an angle if between the relative direction \vec{OO}′ and the reference direction axis Y_{A}″. Based on the angle δ′, users can adjust the communication device A toward the relative direction \vec{OO}′ to elevate communication quality. The antenna pattern e′ is in a direction responding to the better communication direction \vec{OO}′. Besides, the angle δ′ can be displayed on a screen 20 on the communication device A for users to make adjustment.

In the same way, the antenna pattern d is in direction of an original antenna pattern of the communication device B. In this case, a reference direction axis Y_{B}″ coincidentally matches an axis of the axis coordinate system (the geographic north N or Y_{B}′). An antenna pattern e is in a direction responding to the better communication direction \vec{OO}′, and δ is an angle between the relative direction \vec{OO}′ and the reference direction axis Y_{B}′ Based on the angle δ, users can adjust the communication device B toward the relative direction \vec{OO}′ to elevate communication quality. The angle δ can be displayed on a screen on the communication device B for users to make adjustment.

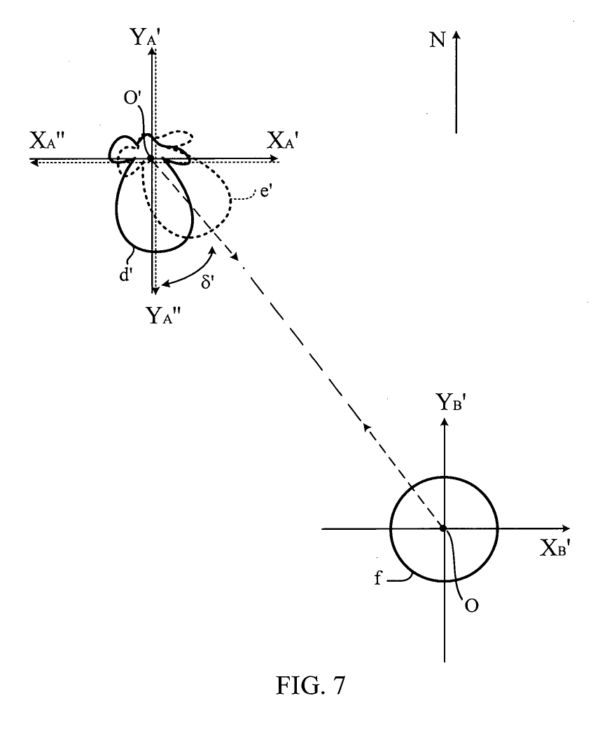

Please refer to FIG. 7. FIG. 7 is a schematic diagram illustrating reference direction coordinate systems and a communication direction between an omni-directional pattern and a directional pattern. The antenna pattern d′ is the antenna pattern orientation of the original communication device A. X_{A}′, Y_{A}′ represents the axis coordinate system. X_{A}″, Y_{A}″ represents the reference direction coordinate system of the communication device A. In this case, the directions of Y_{A}′ and Y_{A}″ are just the opposite, and the directions of X_{A}′ and X_{A}″ are opposite as well. Similarly, after the orientations of the antenna pattern d′, an antenna pattern f, and a relative location were acquired, a better communication is to make the antenna patterns d′ and f face each other, in other words, to make orientations of antenna pattern d′ and f locate on the relative direction \vec{OO}′. The difference between FIG. 7 and FIG. 6 is that the communication device B in FIG. 7 is an omni-directional pattern. So only the appropriate rotation of the communication device A is needed, from the antenna pattern d′ to the antenna pattern e′.

As shown in FIG. 7, the communication device A calculates an angle δ′ between the relative direction \vec{OO}′ and the reference direction axis Y_{A}″ Based on the angle δ′, users can adjust the communication device A toward the relative direction \vec{OO}′ to elevate communication quality.

### Second Embodiment

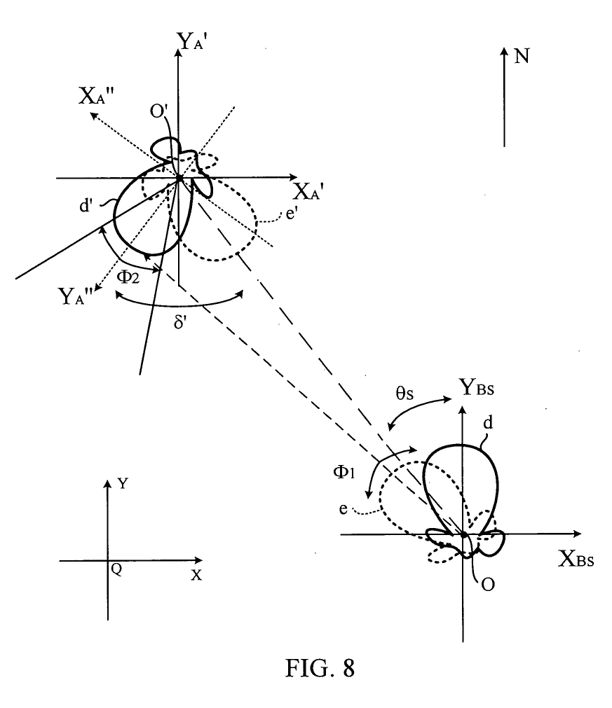

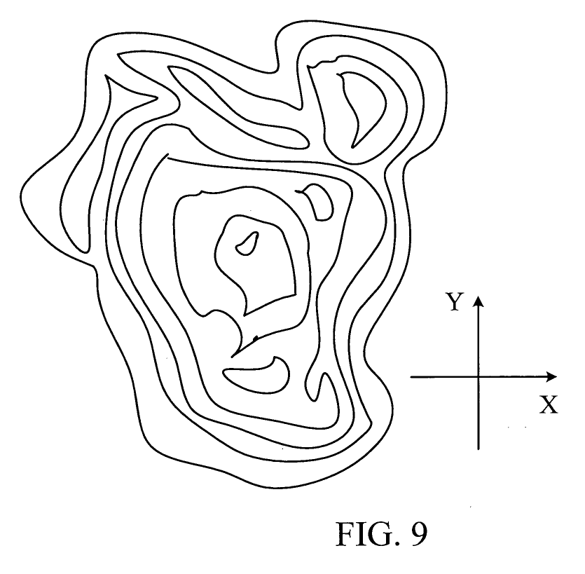

Please refer to FIG. 8. FIG. 8 is a schematic diagram illustrating reference direction coordinate systems and a communication direction between a smart antenna and a directional pattern. To adopt a smart antenna rather than traditional scanning technology for judging a main beam orientation may quicken the generating time of a main beam and shrink switching time of the smart antenna in different orientations. X_{A}″, Y_{A}″ is a reference direction coordinate system of a communication device A. The reference direction coordinate system is defined by an antenna pattern d′. The Φ2 is the range of a main beam that belongs to the antenna pattern d′. An antenna pattern d in FIG. 8 is an original orientation of a communication device B. The communication device b here can be a system end (i.e. base station). The absolute positions of the communication device A and the communication device B (i.e. origins O′ and O) can be located utilizing a positioning module 16, and further to acquire a relative location between the communication device A and the communication device B.

As shown in FIG. 8, if is an angle between a relative direction \vec{OO}′ and a reference direction axis Y_{A}″, while θₛ is an angle between the relative direction \vec{OO}′ and a reference direction axis Y_{BS}. Antenna patterns e and e′ are in direction of better communication direction \vec{OO}′. Φ1 is the range of a main beam belonged to the antenna pattern e. Better communication quality can be achieved by matching the main beam with Φ1 of the communication device B into the range of the main beam with Φ2 of a mobile device end (the communication device A).

The invention utilizes the smart antenna to quicken the generating speed of beam-forming. To the base station with a smart antenna, beam-forming to a client end, which implements the invention, may save the switching time for the smart antenna to switch between different dimensions. It optimizes the service quality and enlarges the number of clients, and is served by a single base station. To the client end, the client end can acquire better communication quality without an expensive smart antenna, only by referring the better communication direction offered by the invention.

### Third Embodiment

Please refer to FIG. 9. FIG. 9 is a schematic diagram illustrating a Received Signal Strength (RSS) distribution map. In the third embodiment, a mobile device (i.e. communication device A) can transmit a present Received Signal Strength (RSS) signal and a corresponding angle δ′ to a system end (i.e. communication device B). Therefore, the system end can generate an RSS distribution map, which has multiple specific spots respectively containing different angle δ′. The users of other communication devices can adjust their communication devices to a better direction according to the RSS distribution map.

Compared to prior art, the invention reduces cost in implementing smart antenna, and optimizes a communication system in practical application. In addition, the invention can associate with Line of Sight (LOS) and None Line of Sight (NLOS) wireless technologies to generate more precisely a better communication direction. For example, when the judgment is Line of Sight, take the first embodiment or the second embodiment as priorities. On the contrary, when the judgment is None Line of Sight, take the third embodiment as priority.

The aforesaid communication system can be applied in not only generating better communication direction but also people searching. The invention may be applied to people searching without a positioning module 16. For example, utilize Time of Arrival (TOA) algorithm to compute multiple distance data between a communication device A and a communication device B. Then, define an axis coordinate system of the communication device B by utilizing an axis sensor 12. Afterward, acquire a relative orientation between the communication device A and the communication device B according to the multiple distance data and the axis coordinate system. Lastly, generate a guiding index showing the relative orientation between the communication device A and the communication device B.

In an embodiment, a communication device B refers to multiple distance data (representing farther or closer distance between a communication device A and the communication device B) in order to acquire the relative orientation between the communication device A and the communication device B.

In an embodiment, a guiding index can be displayed on a screen 20 for an easy browsing. Besides, an axis sensor can be replaced with a gyroscope to record the user's pattern information, so as to make the guiding index more precise. If both communication device A and communication device B have a positioning module 16 (i.e. GPS), the communication device B can directly generate the guiding index from an absolute coordinate. The absolute coordinate is provided by a positioning module accompanied with a distance generated by a singular Time of Arrival (TOA) algorithm.

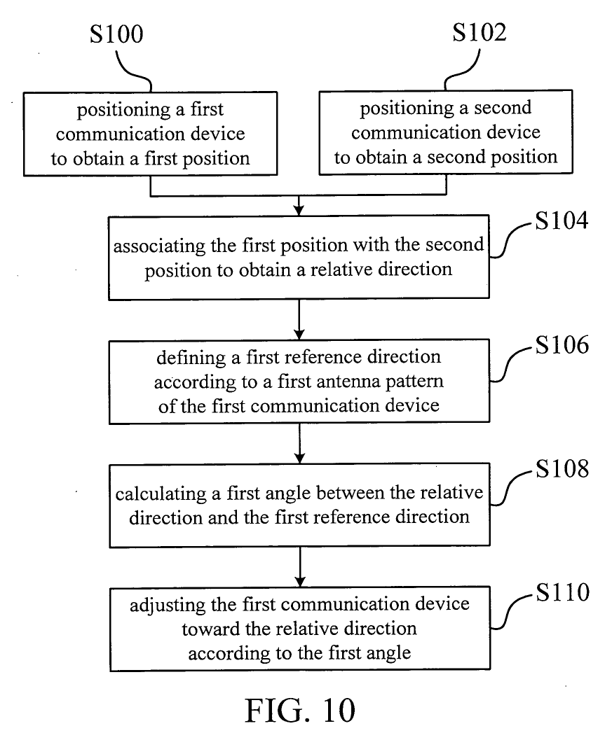

Please refer to FIG. 10. FIG. 10 is a flowchart illustrating an embodiment of a method for generating a better communication direction of the invention. First, step S100 is performed to position a first communication device to obtain a first position, and step S102 is performed to position a second communication device to obtain a second position. Afterward, step S104 is performed to associate the first position with the second position to obtain a relative direction. Step S106 is then performed to define a first reference direction according to a first antenna pattern of the first communication device. Step S108 is then performed to calculate a first angle between the relative direction and the first reference direction. Finally, step S110 is performed to adjust the first communication device toward the relative direction according to the first angle. Until now, the first communication device has been processing communication toward a better communication direction. The flow details of each step are disclosed in aforesaid content.

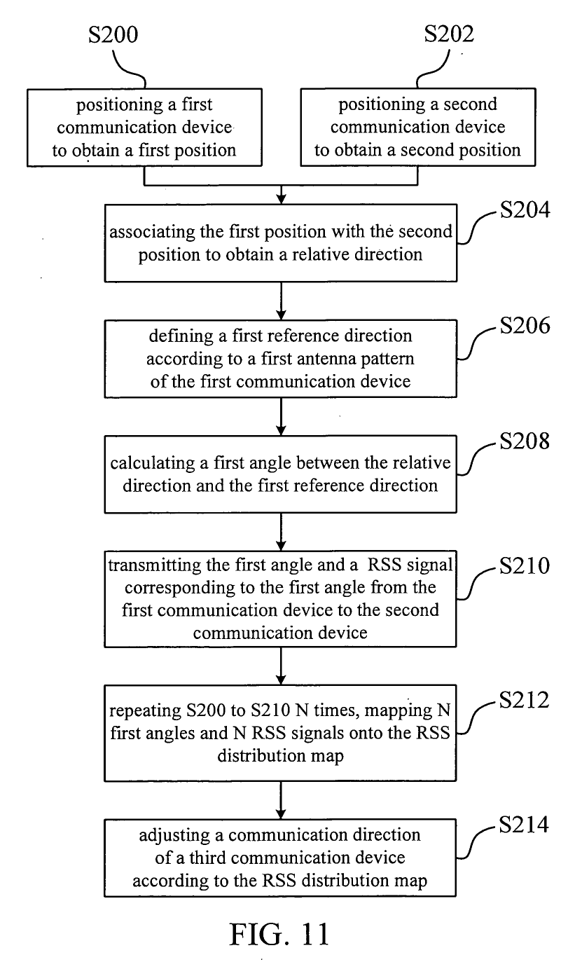

Please refer to FIG. 11. FIG. 11 is a flowchart illustrating another embodiment of a method for generating a better communication direction of the invention. First, step S200 is performed to position a first communication device to obtain a first position, and step S202 is performed to position a second communication device to obtain a second position, wherein the second communication device has a Received Signal Strength (RSS) distribution map. Afterward, step S204 is performed to associate the first position with the second position to obtain a relative direction. Step S206 is then performed to define a first reference direction according to a first antenna pattern of the first communication device. Step S208 is then performed to calculate a first angle between the relative direction and the first reference direction. Step S210 is then performed to transmit the first angle and an RSS signal, which corresponds to the first angle, from the first communication device to the second communication device. Step S212 is then performed to repeat S200 to S210 for N times, so as to map N first angles and N RSS signals onto the RSS distribution map, wherein N is a positive integer. In the end, step S214 is performed to adjust a communication direction of a third communication device according to the RSS distribution map. Until now, the third communication device has been processing communication toward a better communication direction. The flow details of each step are disclosed in aforesaid content.

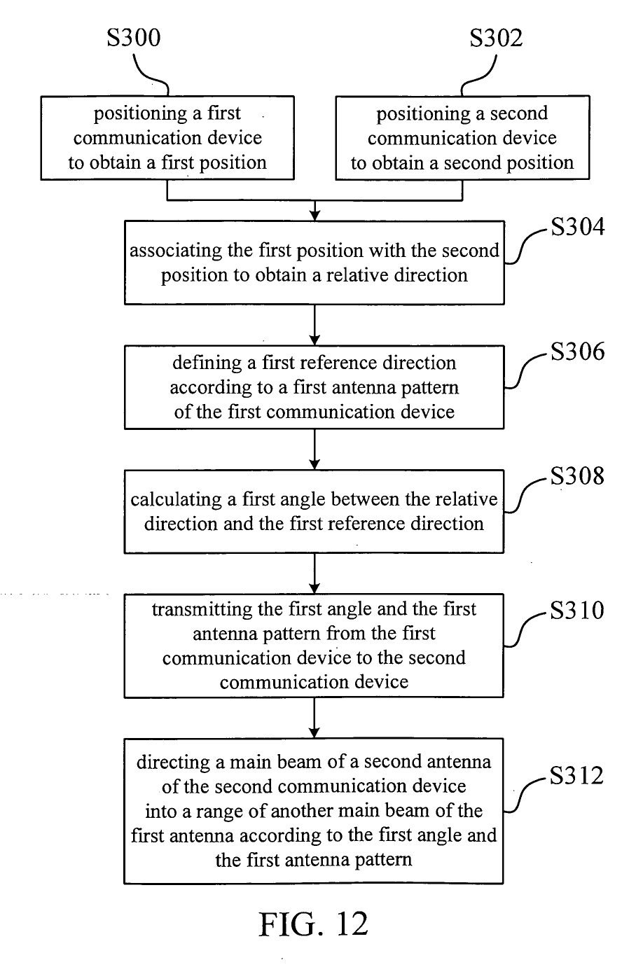

Please refer to FIG. 12. FIG. 12 is a flowchart illustrating another embodiment of a method for generating a better communication direction of the invention. First, step S300 is performed to position a first communication device to obtain a first position, and step S302 is performed to position a second communication device to obtain a second position. Afterward, step S304 is performed to associate the first position with the second position to obtain a relative direction. Step S306 is then performed to define a first reference direction according to a first antenna pattern of the first communication device. Step S308 is then performed to calculate a first angle between the relative direction and the first reference direction. Step S310 is then performed to transmit the first angle and the first antenna pattern from the first communication device to the second communication device. Finally, according to the first angle and the first antenna pattern, step S312 is performed to direct a main beam of a second antenna of the second communication device into a range of another main beam of the first antenna. Until now, the first communication device has been processing communication toward a better communication direction. The flow details of each step are disclosed in aforesaid content.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A method for generating better communication direction, comprising steps of:
positioning a first communication device to obtain a first position;
positioning a second communication device to obtain a second position;
associating the first position with the second position to obtain a relative direction;
defining a first reference direction according to a first antenna pattern of the first communication device;
calculating a first angle between the relative direction and the first reference direction; and
adjusting the first communication device toward the relative direction according to the first angle.

2. The method of claim 1, comprising steps of:
utilizing the second communication device and at least one third communication device to position the first communication device; and
utilizing the first communication device and the at least one third communication device to position the second communication device.

3. The method of claim 1, comprising step of:
utilizing at least two third communication devices to respectively position the first communication device and the second communication device.

4. The method of claim 1, comprising step of:
utilizing a first axis sensor of the first communication device to define the first reference direction according to the first antenna pattern.

5. The method of claim 1, comprising step of:
displaying the first angle on the first communication device.

6. The method of claim 1, comprising steps of:
defining a second reference direction according to a second antenna pattern of the second communication device;
calculating a second angle between the relative direction and the second reference direction; and
adjusting the second communication device toward the relative direction according to the second angle.

7. The method of claim 6, comprising step of:
utilizing a second axis sensor of the second communication device to define the second reference direction according to the second antenna pattern.

8. The method of claim 6, comprising step of:
displaying the second angle on the second communication device.

9. A method for generating better communication direction, comprising steps of:
a) positioning a first communication device to obtain a first position;
b) positioning a second communication device to obtain a second position, wherein the second communication device has a Received Signal Strength (RSS) distribution map;
c) associating the first position with the second position to obtain a relative direction;
d) defining a first reference direction according to a first antenna pattern of the first communication device;
e) calculating a first angle between the relative direction and the first reference direction;
f) transmitting the first angle and a RSS signal, which is corresponding to the first angle, from the first communication device to the second communication device;
g) repeating step a) to step f) for N times, mapping N first angles and N RSS signals onto the RSS distribution map, wherein N is a positive integer; and
h) adjusting a communication direction of a third communication device according to the RSS distribution map.

10. The method of claim 9, wherein the second communication device is a system end.

11. The method of claim 9, comprising step of:
utilizing the second communication device and at least a fourth communication device to position the first communication device.

12. The method of claim 9, comprising step of:
utilizing at least two fourth communication devices to position the first communication device.

13. The method of claim 9, comprising step of:
utilizing a first axis sensor of the first communication device to define the first reference direction according to the first antenna pattern.

14. The method of claim 9, comprising step of:
displaying the first angle on the third communication device.

15. A method for generating better communication direction, comprising steps of:
positioning a first communication device to obtain a first position;
positioning a second communication device to obtain a second position;
associating the first position with the second position to obtain a relative direction;
defining a first reference direction according to a first antenna pattern of the first communication device;
calculating a first angle between the relative direction and the first reference direction;
transmitting the first angle and the first antenna pattern from the first communication device to the second communication device; and
according to the first angle and the first antenna pattern, directing a main beam of a second antenna of the second communication device into a range of another main beam of the first antenna.

16. The method of claim 15, wherein the second communication device is a system end.

17. The method of claim 15, comprising step of:
utilizing the second communication device and at least one third communication device to position the first communication device.

18. The method of claim 15, comprising step of:
utilizing at least two third communication devices to position the first communication device.

19. The method of claim 15, comprising step of:
utilizing a first axis sensor of the first communication device to define the first reference direction according to the first antenna pattern.

20. The method of claim 15, comprising step of:
displaying the first angle on the first communication device.
